(19) United States
(12) Patent Application Publication
(10) Pub. No.: US 2003/0003203 A1
(43) Pub. Date: Jan. 2, 2003

(54) Animal feed additive containing humates and a method of using this additive

(76) Inventor: David Williams, Katy, TX (US)

Correspondence Address: Attn: James H. Riley II, SHOOK, HARDY & BACON L.L.P., Suite 1600, 600 Travis Street, Houston, TX, 77002-2911, US

(21) Appl. No.: 10/058,504

(22) Filed: May 15, 2002

Related U.S. Application Data
(63) Continuation of application No. 09/470,393, filed on Dec. 22, 1999, now abandoned.

(51) Int. Cl. A23K 1/00

(52) U.S. Cl. 426/332

(57) ABSTRACT

An animal feed additive that includes an effective amount of a naturally occurring source of humic acids and fulvic acids is provided. Preferably, this animal feed additive includes at least about 25% humic acids and fulvic acids in combination on a dry weight basis. This animal feed additive may be combined with nutrients to form an animal feed, which is another aspect of the present invention. Still further, the present invention includes a method of feeding animals the feed described above.

### STATEMENT REGARDING FEDERALLY SPONSORED RESEARCH OR DEVELOPMENT

Not applicable.

### CROSS-REFERENCE TO RELATED APPLICATIONS

Not applicable.

### BACKGROUND OF THE INVENTION

The present invention relates to an animal feed additive containing humates and a method of using this additive. More specifically, the feed additive of the present invention includes humic acids and fulvic acids.

Currently, antibiotic growth promoters are available for animals. Examples of antibiotic growth promoters are Maxis™, which is made by Eli Lilly and contains the active ingredient avalamycin, and Enterodox™, which is also made by Eli Lilly and contains the active ingredient olaquindox. However, one disadvantage with antibiotic growth promoters is that they are inefficient, requiring large amounts of food for small increases in animal growth. Commonly used antibiotic growth promoters increase growth between about 1.5% and 3.6% and increase food conversion between about 2.0% and 2.5%. Another disadvantage with these promoters is that the animal waste that results from use of these promoters is not a good quality for use on cropland. Still another disadvantage with these antibiotic growth promoters is that they cause increased microbial resistance to antibiotics in the animals.

Still further, offensive fecal odor may originate from volatile nitrogen compounds deposited in animal waste because of incomplete nitrogen utilization by the animal. Another disadvantage with antibiotic growth promoters is that they do not improve fecal odor, which is becoming a greater problem in confinement animal feeding operations.

In order to overcome these disadvantages, an animal feed additive that is more efficient in stimulating growth in animals is needed. In addition, improved fecal odor should result after feeding animals this additive. Still further, animal waste resulting from this additive, should have an improved quality for cropland applications.

### SUMMARY OF THE INVENTION

It is an object of the present invention to provide an animal feed additive that increases an animal's feed intake, growth rate and feed efficiency so that animal production efficiency is enhanced, and also improves the animal's overall health.

It is another object of the present invention to provide an animal feed additive that helps an animal to further digest its food so that the odor from the animal's manure is decreased and manure quality for cropland applications is improved.

According to the present invention, the foregoing and other objects are achieved by an animal feed additive that includes an effective amount of a naturally occurring source of humic acid and fulvic acid. Another aspect of the present invention is an animal feed that includes nutrients and the animal feed additive of the present invention. Still another aspect of the present invention is a method of feeding animals the feed additive of the present invention.

Additional objects, advantages and novel features of the invention will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### DETAILED DESCRIPTION OF THE PREFERRED EMBODIMENT

The animal feed additive of the present invention is comprised of humates. Humates are naturally occurring carbon containing substances that include various biologically active and inactive compounds. These compounds are derived from humic substances and include humus, humic acid, fulvic acid, and humin, all of which can be described as naturally occurring high-molecular weight complex polymers synthesized through both biotic and abiotic reactions.

Humates are currently used as fertilizers for plants such as crops. They provide a physical modification of soil structure and texture, thus improving aeration and moisture holding capacity in the soil. They also hold minerals and macro nutrients in available and soluble forms that can be assimilated and used by plants. Still further, they provide direct plant stimulation by supplying a slow release of auxin, amino acids and organic phosphate, thus regulating hormone levels that tend to undergo rapid changes in stressed plants. In addition, they serve as a substrate supporting the growth and proliferation of beneficial soil micro-organisms.

The most biochemically active and plant responsive humic substances are naturally occurring humic and fulvic acids. They can be applied to the soil in a dry or liquid form or directly to plant foliage in liquid form. When they are applied, a number of physical benefits are provided including increased water holding capacity of soil, increased aeration of soil, improved soil workability, improved seed bed, reduced soil erosion, and improved drought tolerance. Chemical benefits are also provided which include an increased percentage of total nitrogen in the soil, neutralized alkaline and acidic soils, maximized ion exchange capacity, maximized mineral uptake, and retention and release of fertilizer in root zones as needed. Still further, biological benefits are provided and include accelerated cell division thus stimulating plant growth, increased cell wall thickness thus extending shelf life, accelerated seed germination, increase of desirable micro-organisms in soil, increased vitamin content in plants, increased length wise root growth, maximized nutrient uptake, increased plant enzyme production, and enhanced photosynthesis.

It has now been found that humates can be a useful animal feed additive or ingredient. The animal feed ingredient of the present invention includes an effective amount of a naturally occurring source of humic and fulvic acids. Preferably, this naturally occurring source is Leonardite. The naturally occurring source may also contain other humic substances such as humin. Preferably, this animal feed ingredient contains at least about 25% humic acids and fulvic acids in combination on a dry weight basis. All percentages expressed throughout this application are percent by weight unless otherwise noted. More preferably, it contains between about 25% and 90% humic acids and fulvic acids in combination on a dry weight basis. Most preferably, it contains between about 40% and 90% humic acids and fulvic acids in combination on a dry weight basis. This animal feed ingredient is combined with nutrients to make the animal feed of the present invention. Preferably, the animal feed contains at least about 0.05% humic acids and fulvic acids in combination. More preferably, the animal feed contains between about 0.5% and 0.75% humic acids and fulvic acids in combination. This feed may be fed to animals such as pigs and cows to increase their feed intake, increase their growth rate, and increase their feed conversion efficiency.

Humates are mineral salts of humic substances such as humic acids or fulvic acids. Humic substances commonly are found within soils, waters, compost, peat, and in carbon containing minerals such as brown coals, low grade lignites, and Leonardites. Most soils and waters of the earth's surface contain some humic substances in the form of humin, humic acids or fulvic acids. Humic substances historically have been re-generated in the soil through practices such as crop rotation, planting legumes, plowing under green manure, and application of compost. The best source of high quality humic substances is from a salt-free deposit of highly oxidized carbon called Leonardite. Leonardite is defined as highly oxidized low grade lignite that contains a relatively high concentration of the smaller molecular units (fulvic acids). The Leonardite is selectively mined, processed, precisely blended, and granulated or powdered before it is used as the feed additive of the present invention.

Humic substances contain a wide variety of molecular components. They are primarily composed of polysaccharides, fatty acids, polypeptides, lignins, esters, phenols, ethers, carbonyls, quinones, lipids, peroxides, various combinations of benzene, acetal, ketal, and lactol, and furan ringed compounds, and aliphatic (carbon chains) compounds. The oxidative degradation of some humic substances produces aliphatic, phenolic, and benzene carboxylic acids in addition to n-alkanes and n-fatty acids. The major phenolic acids released contain approximately 3 hydroxyl (—OH) groups and between 1 and 5 carboxyl (—COOH) groups. Humic substances can be subdivided into three major fractions: humin, humic acids, and fulvic acids. These subdivisions are arbitrarily based on the solubility of each fraction in water adjusted to different pH conditions.

Humic substances are the components of humus, a brown to black, hydrophilic, molecularly flexible polyelectrolyte complex of carbon containing compounds not recognized under a light microscope as possessing cellular organization in the form of plant and animal bodies. Many of the components of humus are heterogenous, relatively large, stable, organic complexes. The elemental analysis of humic substances reveals that they are primarily composed of carbon, oxygen, hydrogen, nitrogen, and sulfur in complex carbon chains C—C—C—C (aliphatic components that make up approximately 40-50% of the total) and 4, 5, and 6 member carbon rings (aromatic components that make up 35-60% of the total) with C—C, C═N, and C═O groupings. The extreme variability in the molecular features of humic substances relates back to the precursor compounds and the environmental conditions under which the humic substances formed.

Humins are that fraction of humic substances which are not soluble in alkali (high pH) and are not soluble in acid (low pH). In fact, humins are not soluble in water at any pH. Humin complexes are considered macro-organic (very large) substances because their molecular weights range from approximately 100,000 to 10,000,000. Their cation exchange capacity is between about 100 and 300 centimoles per kilogram (c mol/kg), making them slower to digest than other humic substances. Their carbon content is between about 550 and 620 g/kg. Their oxygen content is between about 340 and 290 g/kg. Their nitrogen content is between about 46 and 55 g/kg. Their hydrogen content is between about 29 and 55 g/kg.

Humic acids comprise a mixture of weak aliphatic (carbon chains) and aromatic (carbon rings) organic acids which are not soluble in water under acidic conditions but are soluble in water under alkaline conditions. Humic acids consist of that fraction of humic substances that are precipitated from aqueous solution when the pH is decreased below 2. Humic acids are termed polydisperse because of their variable chemical features. From a three dimensional aspect, these complex carbon containing compounds are considered to be flexible, linear polymers that exist as random coils with cross-linked bonds. On average, 35% of humic acid molecules are aromatic (carbon rings), while the remaining components are in the form of aliphatic (carbon chains) molecules. The molecular size of humic acids range from approximately 10,000 to 100,000. Peripheral pores in the polymer are capable of accommodating (binding) natural and synthetic organic chemicals in a lattice type arrangement. Humic acids readily form salts with inorganic trace mineral elements, which may include any of over 60 different mineral elements, and function as organo-metal chelates. In addition to the beneficial effects of the humic acids, these trace elements are also useful to animals. The cation exchange capacity of humic acids is between about 300 and 500 c mol/kg. Their carbon content is between about 520 and 560 g/kg. Their oxygen content is between about 360 and 440 g/kg. Their nitrogen content is between about 43 and 55 g/kg. Their hydrogen content is between about 33 and 67 g/kg.

Fulvic acids are a mixture of weak aliphatic and aromatic organic acids which are soluble in water at all pH conditions (acidic, neutral and alkaline). Their composition and shape varies considerably. The size of fulvic acids is smaller than humic acids, with molecular weights which range from approximately 1,000 to 10,000. Fulvic acids have an oxygen content twice that of humic acids. They have many carboxyl (—COOH) and hydroxyl (—OH) groups, thus fulvic acids are much more chemically reactive than humic acids. The exchange capacity of fulvic acids is more than double that of humic acids due to the amount of carboxyl groups present, which ranges from 520 to 1120 c mol (H⁺)/kg. Fulvic acids collected from many different sources, show no evidence of methoxy groups (—OCH₃) groups. In addition, fulvic acids are low in phenols and are less aromatic than humic acids from the same sources. Their carbon content is between about 430 and 520 g/kg. Their oxygen content is between about 440 and 510 g/kg. Their nitrogen content is between about 7 and 43 g/kg. Their hydrogen content is between about 33 and 50 g/kg.

The animal feed additive of the present invention may be fed to any animal to enhance the animal's production efficiency without causing detriment to the animal's health. Energy stored within the carbon bonds of the humates functions to provide energy to the animal for metabolic reactions. Still further, humic and fulvic acids increase cell permeability by easing mineral elements' movement back and forth through the cell membranes, resulting in an increased transport of various mineral nutrients to sites of metabolic need. In addition, humic substances are able to hold water and minerals, which also may be provided to the animal. The additive of the present invention works to increase an animal's feed intake, growth rate, and feed conversion efficiency so as to reduce the costs of raising the animal making the animal more profitable. In most cases, the feed additive of the present invention can increase an animal's feed intake by at least about 3%, increase an animal's growth rate or daily liveweight gain by at least about 5%, and increase an animal's feed conversion efficiency by at least about 3%. Preferably, an animal's feed intake is increased by at least about 10%, an animal's growth rate is increased by at least about 7%, and an animal's feed conversion efficiency is increased by at least about 8% over the positive control Maxis™.

The feed additive of the present invention is especially useful as a feed additive for cows, pigs and chickens. This feed additive improves feed digestibility and utilization. More specifically, the feed additive lowers gastric pH causing better digestion. Still further, it reduces the flow of undigested fermentable protein to the hind gut. The resulting product that is created after using this organic feed additive is a healthier animal and more wholesome pork, beef, chicken or other meat.

The animal feed additive of the present invention also improves animal waste (manure) quality for cropland applications and decreases offensive fecal odor. Nitrogen digestion is improved with this animal feed additive so as to reduce the excretion of potentially polluting nitrogenous compounds. Still further, the condition of the dung during the six week post-weaning period is significantly improved after using the feed additive of the present invention.

Also, the feed additive of the present invention improves overall immune response increase significantly. Lymphocytes increase linearly with increased feed additive inclusion levels. They increased 10.7% in pigs fed a 0.25% feed additive supplemented feed. Natural kill cells also increase linearly with increased feed additive used. They increased 23.7% in pigs fed a 0.25% Feed additive supplemented feed.

In addition, scouring decreases after using the feed additive of the present invention. In fact, in many cases, the number of pigs seen to scour is reduced by about 10% in the first week of post-weaning and is reduced by about 2% for the next four weeks. In fact, in some cases, the number of pigs seen to scour is reduced by about 17% in the first week of post-weaning and is reduced by about 5% for the next four weeks.

The following examples show properties of animal feed additives of the present invention and the effects of these additives on cows and pigs. These examples are not meant in any way to limit the scope of this invention.

### EXAMPLE 1

48 crossbred (Brangus×Gelbvieh) steers were divided into four groups and fed one of four different diets. Three of the groups were fed diets containing various amounts of a feed additive obtained from Huma Tech, Inc. containing a maximum of 65% humic acids and fulvic acids in combination, and one group was the control group and thus did not receive any humates. Feed additive was fed to steers in amounts of 0.78% (2.5 oz/head/day), 1.56% (5 oz/head/day), and 3.12% (10 oz/head/day) of their diets. Diets were formulated to meet the nutrient requirements of the steers. The following table shows ingredients and chemical compositions of the various feed additive diets fed to the steers.

Feed Additive, %

| | 0 | .78 | 1.56 | 3.12 |
|---|---|---|---|---|
| Basal Diet | 80 | 80 | 80 | 80 |
| Flaked corn | | | | |
| Cottonseed hulls | 11.88 | 11.88 | 11.88 | 11.88 |
| TAES 500 | 5 | 5 | 5 | 5 |
| Humates | 0 | .78 | 1.56 | 3.12 |
| Rice hulls | 3.12 | 2.34 | 1.56 | 0 |
| Analysis^{a} | | | | |
| Dry matter, % | 89 | 89 | 89 | 89 |
| Crude protein, % | 10.6 | 10.2 | 10.1 | 10.7 |
| ADF, % | 10.6 | 13.2 | 13.9 | 14.5 |
| NDF, % | 17.9 | 19.9 | 19.5 | 20.1 |
| NE_{m,}Mcal/lb | .92 | .91 | .92 | .91 |
| NE_{g,}Mcal/lb | .62 | .62 | .62 | .62 |
| Calcium, % | .47 | .49 | .40 | .58 |
| Phosphorus, % | .41 | .42 | .40 | .43 |
| Magnesium, % | .16 | .18 | .17 | .19 |
| Potassium, % | .56 | .59 | .60 | .65 |
| Sodium, % | .06 | .06 | .06 | .08 |
| Sulfur, % | .12 | .12 | .12 | .13 |
| Iron, ppm | 201 | 374 | 274 | 346 |
| Zinc, ppm | 33 | 40 | 32 | 37 |
| Copper, ppm | 5 | 8 | 6 | 8 |
| manganese, ppm | 18 | 26 | 17 | 20 |

^{a}Dry matter basis (except dry matter).

As shown in the next table, serum metabolites concentrations were affected by diet. There was a significant increase in serum calcium and a decrease in serum inorganic phosphorus concentrations in steers fed 1.56% feed additive when compared with either the control steers or steers fed 0.78% feed additive. Still further, feeding feed additive to steers at 0.78%, 1.56%, or 3.12% increased serum calcium and hemaglobin, suggesting that consistent blends of humates could improve the production efficiency of livestock. In addition, a linear increase of serum hemoglobin was observed with increasing feed additive concentrations. All other serum metabolites concentrations were similar and within normal range and therefore are not shown. The data indicated that feeding feed additive at concentrations 3.12% did not impair liver function of beef steers or otherwise negatively effect the health status of the steers.

Influence of Feed Additive (Type I-finer feed) on Serum Metabolites of Finishing Feedlot Steers

| | Feed Additive, % | | | | |
|---|---|---|---|---|---|
| | 0 | 0.78 | 1.56 | 3.12 | SE^{a} |
| Calcium, mg/dL | 10.1^{b} | 10.1^{b} | 10.8^{c} | 10.5^{bc} | .15 |
| Phosphorus, mg/dL | 6.9^{b} | 6.7^{b} | 5.7^{c} | 6.3^{bc} | .30 |
| Bilirubin, mg/dL | .14^{b} | .18^{bc} | .18^{bc} | .22^{c} | .02 |
| Hemoglobin, mg/dL | 29.0 | 32.8 | 36.6 | 42.2 | 4.20 |

^{a}Standard error of the mean (n = 12).
^{bc}Row means differ (p < .05).

As shown in the following table, during the first 28 day period, steers treated with 0.78% and 1.56% feed additive gained 4 pounds more than the control. Steers treated with 0.78% feed additive used 12% less feed per pound of gain when compared with the control steers. From day 29 to 56, the control steers gained a total of 10 pounds more than any of the feed additive treated groups. However, this may be able to be attributed to limited nutrient availability because the steers were fed a coarser feed that was more difficult to digest.

Influence of Feed Additive on the Performance of Finishing Feedlot Steers.

| | Feed Additive, % | | | | |
|---|---|---|---|---|---|
| | 0 | 0.78 | 1.56 | 3.12 | SE^{a} |
| Type I - Fine | | | | | |
| Day 0-28 | | | | | |
| Intake, lb/hd/d | 20.5 | 19.1 | 19.9 | 20.1 | .81 |
| Gain, lb | 90 | 94 | 94 | 87 | 5.21 |
| ADG, lb/hd/d | 3.21 | 3.36 | 3.34 | 3.10 | |
| Feed:Gain ratio | 6.6 | 5.8 | 6.1 | 6.8 | .41 |
| Type II - Coarse | | | | | |
| Day 29-56 | | | | | |
| Intake, lb/hd/d | 19.4 | 19.7 | 20.6 | 20.7 | .82 |
| Gain, lb | 103 | 87 | 98 | 93 | 8.41 |
| ADG, lb/hd/d | 3.69 | 3.11 | 3.51 | 3.32 | |
| Feed:Gain ratio | 5.8 | 7.0 | 6.5 | 6.8 | .74 |
| Day 0-56 | | | | | |
| Intake, lb/hd/d | 19.9 | 19.4 | 20.2 | 20.3 | .68 |
| Gain, lb | 193 | 181 | 192 | 176 | 10.90 |
| ADG, lb/hd/d | 3.45 | 3.24 | 3.42 | 3.15 | |
| Feed:Gain ratio | 6.1 | 6.1 | 6.2 | 6.6 | .40 |

^{a}Standard error of the mean (n = 12).

As shown in the following table, steers treated with 3.12% feed additive indicated a 17 pound increase in total weight gain, a 15.6% increase in rate of gain and utilized 15% less feed when compared with the control steers. Steers fed 3.12% feed additive made 23% more visits to the feed trough than the control steers, and consumed 15% less feed per visit. The control steers spent 9% less time eating per day when compared with any of the feed additive treated groups. Increasing feed additive rations tended to increase the number of visits to the feed troughs, thus suggesting that feed additive created no palatability problems.

Influence of Feed Additive on the Post-Trial Performance of Finishing Feedlot Steers

| | Feed Additive, % | | | | |
|---|---|---|---|---|---|
| | 0 | 0.78 | 1.56 | 3.12 | SE^{a} |
| Day 0-84 | | | | | |
| Intake, lb/hd/d | 21.2 | 20.9 | 20.5 | 21.9 | |
| Gain, lb | 304 | 290 | 296 | 304 | |
| ADG, lb/hd/d | 3.61 | 3.46 | 3.53 | 3.61 | |
| Feed:Gain ratio | 5.9 | 6.0 | 5.8 | 6.1 | |
| Day 29-84 | | | | | |
| Intake lb/hd/d | 20.9 | 21.0 | 20.7 | 22.1 | |
| Gain, lb | 213 | 196 | 203 | 220 | |
| ADG, lb/hd/d | 3.81 | 3.50 | 3.62 | 3.93 | |
| Feed:Gain ratio | 5.5 | 6.0 | 5.7 | 5.6 | |
| Day 57-84^{d} | | | | | |
| Intake, lb/hd/d | 22.5 | 22.3 | 20.8 | 23.4 | |
| Gain, lb | 110^{b} | 109^{b} | 105^{b} | 127^{c} | 5.12 |
| ADG, lb/hd/d | 3.92^{b} | 3.88^{b} | 3.74^{b} | 4.53^{c} | 0.18 |
| Feed:Gain ratio | 5.7 | 5.8 | 5.6 | 5.2 | |

^{a}Standard error of the mean (n = 12).
^{bc}Row means differ (P < .05).
^{d}Post-trial performance.

### EXAMPLE 2

72 British or British crossbred steers were fed one of four diets, three of the diets contained various amounts of humates, and the other diet was the control diet and thus contained no humates. During the trial, the particle size of the humate was changed from a fine particle size to a coarse particle size. The following tables show the results of this trial.

Effect of Level of Feed Additive Humate on Manure Nutrient Composition (two reps).

| | Level of Humate | | | | |
|---|---|---|---|---|---|
| | Control | Low | Medium | High | |
| | (Og/ton) | (2270 g/ton) | (4540 g/ton) | (9080 g/ton) | SD |
| Moisture | 76.38^{a} | 76.52^{a} | 77.69^{b} | 76.24^{a} | 0.53 |
| WB, % | | | | | |
| Ash | 13.52^{a} | 15.60b^{c} | 16.30^{c} | 14.27^{ab} | 0.76 |
| DB, % | | | | | |
| Dry | 23.62^{a} | 23.48^{a} | 22.31^{b} | 23.76^{a} | 0.53 |
| Matter | | | | | |
| WB, % | | | | | |
| N, %* | 2.38^{a} | 2.64^{b} | 2.37^{a} | 2.46^{a} | 0.05 |
| P, %* | 0.70^{a} | 0.77^{b} | 0.68^{a} | 0.67^{a} | 0.02 |
| K, %* | 0.91^{a} | 1.10^{b} | 0.75^{c} | 0.73^{c} | 0.04 |
| Ca, %* | 1.66^{a} | 1.72^{ab} | 2.06^{c} | 1.95^{bc} | 0.09 |
| Mg, %* | 0.38^{a} | 0.43^{b} | 0.45^{b} | 0.42^{ab} | 0.02 |
| Na, ppm^{a}* | 982.80^{a} | 770.22^{b} | 985.21^{a} | 1048.21^{a} | 56.47 |
| Zn, ppm* | 96.50^{a} | 104.34^{b} | 85.67^{c} | 103.22^{ab} | 2.43 |
| Fe, ppm* | 816.6^{a} | 1549.4^{b} | 1707.3^{b} | 1107.1^{c} | 74.18 |
| Cu, ppm* | 23.72^{a} | 23.59^{a} | 26.70^{b} | 28.09^{b} | 0.96 |
| Mn, ppm* | 81.64^{a} | 92.41^{b} | 60.26^{c} | 56.97^{c} | 2.57 |

*Values reported on a dry matter basis.
^{abc}Means with different superscripts differ (P < .05).

Effect of Time on Manure Nutrient Composition (two reps).

| | Date of Collection | | | | | | | |
|---|---|---|---|---|---|---|---|---|
| | 8/7/97 | 8/14/97 | 8/21/97 | 8/28/97 | 9/4/97 | 9/11/97 | 9/18/97 | SE |
| Moisture | 72.00^{a} | 75.93^{b} | 75.23^{b} | 78.77^{c} | 78.98^{c} | 77.35^{d} | 78.71^{c} | 0.53 |
| WB, % | | | | | | | | |
| Ash DB, % | 18.51^{a} | 13.24^{c} | 15.52^{b} | 13.36^{c} | 16.71^{ab} | 16.52^{b} | 10.60^{d} | 0.76 |
| Dry Matter | 27.99^{a} | 24.07^{b} | 24.77^{b} | 21.23^{c} | 21.02^{c} | 22.65^{d} | 21.29^{c} | 0.53 |
| WB, % | | | | | | | | |
| N, %* | 2.11^{a} | 2.53b^{d} | 2.03^{a} | 2.92^{c} | 2.38^{b} | 2.65^{d} | 2.61^{d} | 0.06 |
| P, %* | 0.61^{a} | 0.63^{a} | 0.60^{a} | 0.63^{a} | 0.97^{b} | 0.85^{c} | 0.64^{a} | 0.03 |
| K, %* | 0.46^{a} | 0.52^{a} | 0.58^{a} | 0.84^{b} | 1.47^{c} | 0.98^{b} | 1.25^{d} | 0.05 |
| Ca, %* | 2.24^{a} | 2.18^{a} | 1.18^{b} | 1.26^{b} | 2.88^{c} | 1.96^{a} | 1.23^{b} | 0.12 |
| Mg, %* | 0.50^{a} | 0.45^{ac} | 0.35^{b} | 0.29^{b} | 0.65^{d} | 0.43^{c} | 0.29^{b} | 0.02 |
| Na, ppm^{a}* | 1006.1^{a} | 916.7^{ab} | 815.4^{ab} | 736.9^{b} | 1739.8^{c} | 918.7^{ab} | 492.6^{d} | 74.71 |
| Zn, ppm* | 101.30^{a} | 107.83^{a} | 76.62^{b} | 87.12^{c} | 123.63^{d} | 108.87^{a} | 76.66^{b} | 3.22 |
| Fe, ppm* | 2653.9^{a} | 2090.2^{b} | 1473.9^{c} | 391.4^{d} | 760.5^{c} | 1224.1^{c} | 471.6^{d} | 98.14 |
| Cu, ppm* | 24.19^{a} | 23.15^{a} | 16.41^{b} | 25.48^{a} | 41.02^{c} | 29.16^{d} | 19.28^{b} | 1.27 |
| Mn, ppm* | 85.35^{ab} | 90.39^{a} | 49.29^{c} | 55.96^{c} | 93.53^{a} | 78.22^{b} | 56.99^{c} | 3.39 |

*Values reported on a dry matter basis.
^{abcde}Means with different superscripts differ (P < .05).

Effect of Level of Humate on Nutrient Composition of Manure, Sampling Weeks 1-4 Only (two reps).

| | Level of Humate | | | | |
|---|---|---|---|---|---|
| | Control | Low | Medium | High | |
| | (Og/ton) | (2270 g/ton) | (4540 g/ton) | (9080 g/ton) | SE |
| Moisture | 75.40^{a} | 74.32^{a} | 77.01^{b} | 75.21^{a} | 0.53 |
| Ash DB, % | 11.63^{a} | 16.47^{b} | 18.78^{c} | 13.76^{a} | 0.76 |
| Dry Matter WB, % | 24.60^{a} | 25.68^{a} | 22.99^{b} | 24.79^{a} | 0.53 |
| N, %* | 2.51^{a} | 2.48^{a} | 2.20^{b} | 2.40^{a} | 0.06 |
| P, %* | 0.60 | 0.63 | 0.65 | 0.58 | 0.02 |
| K, %* | 0.64^{a} | 0.71^{b} | 0.53^{c} | 0.52^{c} | 0.02 |
| Ca, %* | 1.07^{a} | 1.74^{a} | 2.44^{c} | 1.61^{b} | 0.11 |
| Mg, %* | 0.32^{a} | 0.39^{b} | 0.57^{c} | 0.37^{ab} | 0.02 |
| Na, ppm^{a}* | 857.91^{a} | 994.20^{a} | 979.05^{a} | 643.93^{b} | 64.27 |
| Zn, ppm* | 93.27^{a} | 104.39^{b} | 82.92^{c} | 92.27^{a} | 2.95 |
| Fe, ppm* | 778.4^{a} | 2044.6^{b} | 2353.2^{b} | 1433.2^{c} | 122.23 |
| Cu, ppm* | 17.28^{a} | 22.59^{b} | 24.93^{b} | 24.43^{b} | 1.16 |
| Mn, ppm* | 79.47^{a} | 92.49^{b} | 56.57^{c} | 52.46^{c} | 2.22 |

*Values reported on a dry matter basis.
^{abc}Means with different superscripts differ (P < .05).

Effect of Time of Sampling on Nutrient Composition of Manure (two reps, weeks 1 through 4 only).

| | Date of Collection | | | | |
|---|---|---|---|---|---|
| Item | 8/7/97 | 8/14/97 | 8/21/97 | 8/28/97 | SE |
| Moisture WB, % | 72.00^{a} | 75.93^{b} | 75.23^{b} | 78.77^{c} | 0.53 |
| Ash DB, % | 18.51^{a} | 13.24^{b} | 15.52^{b} | 13.36^{b} | 0.76 |
| Dry Matter | 27.99^{a} | 24.70^{b} | 24.77^{b} | 21.23^{c} | 0.53 |
| WB, % | | | | | |
| N, %* | 2.11^{a} | 2.53^{b} | 2.03^{a} | 2.92^{c} | 0.06 |
| P, %* | 0.61 | 0.63 | 0.60 | 0.63 | 0.02 |
| K, %* | 0.46^{a} | 0.52^{b} | 0.58^{b} | 0.84^{c} | 0.02 |
| Ca, %* | 2.24^{a} | 2.18^{a} | 1.18^{b} | 1.26^{b} | 0.11 |
| Mg, %* | 0.50^{a} | 0.45^{a} | 0.35^{b} | 0.29^{b} | 0.02 |
| Na, ppm^{a}* | 1006.13^{a} | 916.66^{ab} | 815.37^{ab} | 736.93^{b} | 64.27 |
| Zn, ppm* | 101.29^{a} | 107.83^{a} | 76.62^{b} | 87.12^{c} | 2.95 |
| Fe, ppm* | 2653.9^{a} | 2090.2^{b} | 1473.9^{c} | 391.4^{d} | 122.23 |
| Cu, ppm* | 24.19^{a} | 23.15^{a} | 16.41^{b} | 25.48^{a} | 1.16 |
| Mn, ppm* | 85.35^{a} | 90.39^{a} | 49.29^{b} | 55.96^{c} | 2.26 |

*Values reported on a dry matter basis.
^{abcde}Means with different superscripts differ (P < .05).

### EXAMPLE 3

240 pigs were divided into three groups. Two groups were fed differing levels of feed additive. One group was fed a popular positive control feed additive antibiotic growth promoter, Enterodox™. The pigs had fresh air ventilation and were offered the diets in a pelleted form on an ad libitum basis.

| | Control | 0.25% Feed Additive | 0.5% Feed Additive |
|---|---|---|---|
| | Prestarter (0.5 kg per pig) | | |
| | DE 16.0 MJ/kg: | | |
| | Crude Protein 22; Lysine 1.65% | | |
| First Stage | Starter | Starter | Starter |
| (Weaning to 28 days) | DE 14.75 MJ/kg: | DE 14.75 MJ/kg: | DE 14.75 MJ/kg: |
| | Crude Protein 20%; | Crude Protein 20%; | Crude Protein 20%; |
| | Lysine 1.5% | Lysine 1.5″ | Lysine 1.5% |
| | Maxis ™ | No antibiotic Growth | No antibiotic Growth |
| | | Promoter | Promoter |
| | | 0.25% feed additive | 0.5% feed additive |
| Second Stage | Grower | Grower | Grower |
| (28 to 42 days) | DE 14.6 MJ/kg: | DE 14.6 MJ/kg: | DE 14.6 MJ/kg: |
| | Crude Protein 22%; | Crude Protein 22%; | Crude Protein 22%′ |
| | Lysine 1.4% | Lysine 1.4% | Lysine 1/4% |
| | Enterodox ™ | No antibiotic Growth | No antibiotic Growth |
| | | Promoter | Promoter |
| | | 0.25% feed additive | 0.50% feed additive |

Comparison of the Performance of Young Weaned Pigs Offered Diets
Containing a Standard Antibiotic Growth Promoter or the Natural Feed
Ingredient Feed Additive During the First 4 Weeks Post-weaning.

| | | 0.25% | 0.50% | | |
|---|---|---|---|---|---|
| | Control | Feed | Feed | | Level of |
| | Maxis ™ | Additive | Additive | SED | Significance |
| Initial Weight (kg) | 7.52 | 7.92 | 7.45 | 0.301 | NS |
| 28 day weight (kg) | 17.95 | 17.34 | 19.18 | 0.823 | NS |
| Feed Intake (g/d) | 796 | 464 | 513 | 38.5 | NS |
| Daily Liveweight Gain (g/d) | 370 | 350 | 417 | 29.8 | NS |
| FCR (g Feed/g Gain) | 1.35^{a} | 1.34^{a} | 1.24^{b} | 0.023 | P < 0.01 |
| Scour Assessment (% of pigs | 7.58^{a} | 5.10^{a} | 1.70^{b} | 1.387 | P < 0.05 |
| scouring) | | | | | |

Values in the same row with the same superscript are non-significantly different.

Comparison of the Performance of Young Weaned Pigs Offered Diets
Containing a Standard Antibiotic Growth Promoter, or the Natural Feed
Ingredient Feed Additive During Weeks 5 and 6 Post-weaning

| | | 0.25% | | | |
|---|---|---|---|---|---|
| | Control | Feed | 0.5% | | Level of |
| | Enterodox ™ | Additive | Feed Additive | SED | Significance |
| 28 day weight (kg) | 17.95 | 17.34 | 19.18 | 0.82 | NS |
| Final Weight (kg) | 27.85 | 26.68 | 29.39 | 1.36 | NS |
| Feed Intake (g/d) | 1,066 | 1,005 | 998.95 | 268.8 | NS |
| Daily Liveweight | 689 | 660 | 717 | 50.0 | NS |
| Gain (g/d) | | | | | |
| FCR (g Feed/g | 1.54^{a} | 1.52^{a} | 1.39^{b} | 0.052 | P < 0.05 |
| Gain) | | | | | |
| Scour Assessment | 2.75^{a} | 0.53^{b} | 0.53^{b} | 0.743 | P < 0.05 |
| (% of pigs | | | | | |
| scouring) | | | | | |

Values in the same row with the same superscript are non-significantly different

Comparison of the Overall Performance of Young Weaned Pigs Offered Diets
Containing a Standard Antibiotic Growth Promoter, or the Natural Feed Ingredient
Feed Additive During the 6 Weeks Post-weaning

| | | Treatment 1 | | | |
|---|---|---|---|---|---|
| | Control | 0.25% | Treatment 2 | | |
| | Maxus/ | Feed | 0.50% | | Level of |
| | Enterodox | Additive | Feed Additive | SED | Significance |
| Initial Weight (kg) | 7.52 | 7.92 | 7.45 | 0.301 | NS |
| Final Weight (kg) | 27.85 | 26.68 | 29.39 | 1.360 | NS |
| Feed Intake (g/d) | 686 | 645 | 675 | 56.6 | NS |
| Daily Liveweight Gain (g/d) | 470 | 450 | 514 | 37.8 | NS |
| FCR (g Feed/g Gain) | 1.46^{a} | .144^{a} | 1.31^{b} | 0.030 | P < 0.01 |
| Scour Assessment | 5.18^{a} | 2.83^{ab} | 1.13^{b} | 0.780 | P < 0.01 |
| (% of pigs scouring) | | | | | |

Values in the same row with the same superscript are non-significantly different.

During zero to four weeks post-weaning, the mean feed intake of the three groups of pigs was found to be similar, although the inclusion of 0.5% feed additive did result in a 3% increase in feed intake. Pigs fed the diet containing 0.5% feed additive gained weight 13% more rapidly than the control pigs. Also, the inclusion of 0.5% feed additive resulted in a significant improvement in food conversion ratio (P<0.01). In addition, those pigs offered the 0.5% feed additive diet converted their feed into liveweight gain 8% more efficiently than the control pigs.

Still further, during the first four post-weaning weeks, those pigs fed a 0.5% feed additive diet were judged to have significantly less loose dung than the other two groups of pigs. During the first week of post-weaning, a maximum of 25% of the control pigs had scours whereas a maximum of only 7.5% of the 0.5% feed additive treated pigs were seen to scour. Over the first four weeks of post-weaning on average, only 1.7% of the pigs fed 0.5% feed additive were seen to scour as compared to 7.58% for the controls and 5.10% for the pigs offered the diet containing 0.25% feed additive.

Five to six weeks after post-weaning, the inclusion of feed additive in the pigs' diets produced a reduction in feed intake of 6% when the diet contained 0.25% feed additive and 28% when included at 0.5%. However, these differences were not found to be significant. The pigs fed the diet containing 0.5% feed additive showed a 4% improvement in growth rate over the control pigs. Six weeks after post-weaning, the 0.5% feed additive pigs were 1.54 kg heavier than the control pigs. Still further, the pigs fed the diet containing 0.5% feed additive converted their feed into liveweight gain significantly (P<0.05) more efficiently than the other two groups of pigs. Also, food conversion ratio was improved by 9.7% when compared to the control pigs. In addition, the percentage of pigs seen to scour was significantly (P<0.05) improved through the inclusion of both 0.25 and 0.5% feed additive. Also, mean levels of losseness were considerently lower in the pigs fed either the 0.25 or 0.5% feed additive diets.

Overall, this experiment showed a 9% improved growth rate and 10% improved food conversion ratio in pigs fed a 0.5% feed additive supplemental feed. The feed additive did not significantly affect feed intake in this experiment.

From the foregoing, it will be seen that this invention is one that is well adapted to attain all the ends and objects herein above set forth together with other advantages which are obvious and inherent to the formulation. It will be understood that certain features and subcombinations are of utility and may be employed without reference to other features and subcombinations. This is contemplated by and is within the scope of the claims. Since many possible embodiments may be made of the invention without departing from the scope thereof, it is to be understood that all matter herein set forth is to be interpreted as illustrative and not in a limiting sense.

I claim:

1. An animal feed ingredient, comprising:
an effective amount of a naturally occurring source of humic acids and fulvic acids.

2. The animal feed ingredient of claim 1, wherein said effective amount comprises at least about 25% humic acids and fulvic acids in combination on a dry weight basis.

3. The animal feed ingredient of claim 2, wherein said effective amount comprises between about 40% and 90% humic acids and fulvic acids in combination on a dry weight basis.

4. The animal feed ingredient of claim 2, wherein said naturally occurring source of humic acids and fulvic acids is Leonardite.

5. The animal feed ingredient of claim 2, wherein said naturally occurring source is further comprised of humins.

6. An animal feed, comprising:
nutrients; and
an effective amount of a naturally occurring source of humic acids and fulvic acids.

7. The feed of claim 6, wherein said feed is comprised of at least about 0.05% humic acids and fulvic acids in combination.

8. The feed of claim 7, wherein said feed is comprised of between about 0.5% and 0.75% humic acids and fulvic acids in combination.

9. A method of feeding animals, comprising:
providing an animal feed comprising nutrients and an effective amount of a naturally occurring source of humic acids and fulvic acids; and
feeding said feed to said animals.

10. The method of claim 9, wherein said animal is a cow, pig or chicken.

11. The method of claim 9, wherein said animal's feed intake is increased by at least about 3%.

12. The method of claim 11, wherein said animal's feed intake is increased by at least about 10%.

13. The method of claim 9, wherein said animal's growth rate is increased by at least about 5%.

14. The method of claim 13, wherein said animal's growth rate is increased by at least about 7%.

15. The method of claim 9, wherein said animal's feed conversion efficiency is increased by at least about 3%.

16. The method of claim 15, wherein said animal's feed conversion efficiency is increased by at least about 8%.

17. The method of claim 9, wherein the number of pigs seen to scour is reduced by about 10% in the first week post-weaning and is reduced by about 2% for the second through the fifth weeks post-weaning.

18. The method of claim 17, wherein the number of pigs seen to scour is reduced by about 17% in the first week post-weaning and is reduced by about 5% for the second through the fifth weeks post-weaning.
